(19) United States
(12) Patent Application Publication
(10) Pub. No.: US 2009/0162670 A1
(43) Pub. Date: Jun. 25, 2009

(54) METHOD FOR APPLYING CERAMIC COATINGS TO SMOOTH SURFACES BY AIR PLASMA SPRAY TECHNIQUES, AND RELATED ARTICLES

(75) Inventors: Yuk-Chiu Lau, Ballston Lake, NY (US); Brian Thomas Hazel, West Chester, OH (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 11/961,644

(22) Filed: Dec. 20, 2007

(51) Int. Cl. B32B 15/04; B05D 1/02; B32B 33/00

(52) U.S. Cl. 428/433; 427/453

(57) ABSTRACT

A method for applying a ceramic coating over a substantially smooth protective coating on a metal substrate is disclosed. The method includes the step of air plasma spraying (APS) particles of the ceramic coating at a pre-selected particle velocity of at least about 500 meters per second. The ceramic coating particles have an average particle size no greater than about 50 microns. An article is also described, including a metal substrate; and a substantially smooth protective coating over the substrate, having a roughness (Ra) less than about 200 micro-inches. An adherent ceramic coating is disposed on the substantially smooth protective coating.

### BACKGROUND OF THE INVENTION

The invention relates generally to protective coatings applied to metals. More specifically, it is directed to methods for plasma-spraying ceramic coatings onto relatively smooth surfaces, e.g., to a turbine engine component on which a smooth metal or ceramic coating has previously been deposited.

Thermal barrier coatings (TBCs) are often used to improve the efficiency and performance of metal parts which are exposed to high temperatures. Aircraft engines and land-based turbines are made from such parts. The combustion gas temperatures present in turbines are maintained as high as possible for operating efficiency. Turbine blades and other elements of the engine are usually made of alloys which can resist the high temperature environment, e.g., superalloys, which have an operating temperature limit of about 1000-1150° C. Operation above these temperatures may cause the various turbine elements to fail and damage the engine.

The thermal barrier coatings effectively increase the operating temperature of the turbine by maintaining or reducing the surface temperature of the alloys used to form the various engine components. Most thermal barrier coatings are ceramic-based, e.g., based on a material like zirconia (zirconium oxide), which is usually chemically stabilized with another material such as yttria. For a turbine, the coatings are applied to various surfaces, such as turbine blades and vanes, combustor liners, and combustor nozzles.

A general example of a turbine blade is depicted in FIG. 1. Usually, a plurality of such blades are attached to an annular rotor disk (not shown). Blade 10 includes an airfoil 12, having pressure and suction sides 14, 16, and leading and trailing edges 18 and 20. The lower part of the airfoil terminates with base 22. Base 22 includes a platform 24, in which the airfoil can be rigidly mounted in an upright position, i.e., substantially vertical to the top surface 25 of the platform. The base further includes a dovetail root 26, attached to the underside of the platform, for attaching blade 10 to the rotor.

As those familiar with the art understand, thermal barrier coatings have been critical for protecting the various surfaces of airfoil 12. A number of coating systems are used for this purpose. As one illustration, an oxidation-resistant bond coat is applied to the substrate initially. The bond coat is often critical for promoting adhesion, and extending the service life of the TBC system. In some cases, diffusion aluminide bond coatings are preferred, e.g., those containing a platinum aluminide intermetallic compound. One exemplary deposition technique involves vapor-phase deposition, e.g., vapor phase aluminiding (VPA). In such a process, platinum is typically first plated onto the substrate. This step is usually followed by the diffusion of aluminum vapor (from solution) into the coating region, with a subsequent heat treatment. The resulting coating is very smooth, and can be relatively thin, while still providing high aluminum content and good oxidation protection.

The TBC applied over the bond coat can also be formed by various techniques. One popular technique is known in the art as electron beam physical vapor deposition (EBPVD or EB-PVD). The EBPVD process is a form of physical vapor deposition, in which a target is bombarded with an electron beam given off by a charged tungsten filament, under high vacuum. The electron beam causes atoms from the target to transform into the gaseous phase. These atoms then precipitate into solid form, coating everything in the vacuum chamber with a thin layer of the target material. In the case of zirconia-based TBC's, the EBPVD process can be very useful for applying durable coatings of a desired thickness to the underlying bond coat. Moreover, adhesion of the TBC to the bond coat is very good.

While an EBPVD process is very useful in some situations, there are also drawbacks to using such a system. For example, EBPVD systems are very costly. The expense involved in purchasing, operating, and maintaining the associated equipment for a given coating application can sometimes be economically unattractive.

Moreover, EBPVD is a line-of-sight deposition process. While the coating apparatus can be adjusted to coat surfaces with different, relative orientations, the efficiency of the overall process may be decreased. The illustrative turbine engine blade of FIG. 1 is instructive in this regard. Traditionally, the primary areas for protective coating systems were the various surfaces of airfoil 12, e.g., pressure and suction surfaces 14 and 16, respectively.

More recently, however, turbine blades like those used in the high-pressure section of a turbine are subject to a more uniform temperature profile. Thus, the base region 22 of the blade, including platform 24, is exposed to greater temperatures, and may also require the protection of a TBC at considerable thickness. However, since platform region 24 is normal to airfoil 12, the blade must be rotated around its central axis to allow for the required amount of coating on platform surface 25. In order to provide the required amount of coating thickness to both the airfoil and the platform region, longer coating periods may be necessary. The longer time periods increase the overall cost of the process, and may also waste coating material. Furthermore, the thickness of the coating on the airfoil and on the platform may vary considerably, and this can represent another significant drawback in some cases.

In view of some of the drawbacks of EBPVD, air plasma spray (APS) techniques have attracted more attention in recent years. As discussed below, APS is a plasma-spray technique utilized to apply various types of coatings, such as TBC's. The APS systems are often far less expensive than a typical EBPVD system. Furthermore the spray torch (i.e., the spray gun) and associated tooling in an APS system can be readily manipulated by robotics to coat parts having complex geometries, as well as surfaces with varying orientations. Moreover, the spray parameters of the APS system can be adjusted to provide a variety of coating microstructures, each of which might be most appropriate for a given situation. For example, the system can be adjusted to provide a porous coating structure, or to provide the dense, vertically-cracked microstructure which is often desirable for a zirconia-based TBC.

While the APS systems provide a number of advantages, there are some drawbacks as well. For example, a rough, underlying surface is usually necessary for an applied APS coating to exhibit appropriate adhesion bond strength for many end use applications. As an example, the underlying surface may need to have a roughness (arithmetic roughness average: “Rₐ”) of at least about 300 micro-inches. The rough surface serves to ensure good adhesion between the APS coating and the underlying substrate, i.e., the part surface itself, or another coating previously applied over the part. Conversely, deposition of an APS coating (such as a TBC) onto a smooth surface, e.g., the vapor-deposited platinum aluminide coatings mentioned above, may lead to relatively poor adhesion. In this instance, the TBC may spall off the underlying surface, especially after heating and cooling cycles. The degradation of the protective coating may lead to damage to the underlying component, unless repairs are undertaken.

It should thus readily be apparent that new processes for applying APS coatings to substrates would be welcome in the art. The new processes should allow the deposition of coatings onto relatively smooth substrates, as described herein. Moreover, use of the processes should result in relatively good adhesion between the APS coating and the underlying coating or substrate. Furthermore, the other physical properties of the APS coatings should be maintained at a sufficient level, for a desired application. The new processes should also not be excessively costly, as compared to current APS coating techniques.

### BRIEF DESCRIPTION OF THE INVENTION

One embodiment of the present invention is directed to a method for applying a ceramic coating over a substantially smooth protective coating on a metal substrate. The method comprises the step of air plasma spraying (APS) particles of the ceramic coating over the substantially smooth protective coating at a pre-selected particle velocity. The ceramic coating particles have an average particle size no greater than about 50 microns. The pre-selected particle velocity in the APS process is at least about 500 meters per second.

Another embodiment of the invention relates to an article which comprises:
(I) a metal substrate;
(II) a substantially smooth protective coating over the substrate, having a roughness (Ra) less than about 200 micro-inches; and
(III) an adherent ceramic coating disposed on the substantially smooth protective coating.

The adherent ceramic coating is one which has been applied by air plasma spraying. In some preferred embodiments, it contains a plurality of substantially vertical microcracks.

These and other embodiments and features of the invention will become better understood with reference to the drawings, detailed description, and claims.

### DESCRIPTION OF THE DRAWINGS

FIG. 1 is a perspective view of a turbine engine blade, including the airfoil, platform, and dovetail root.

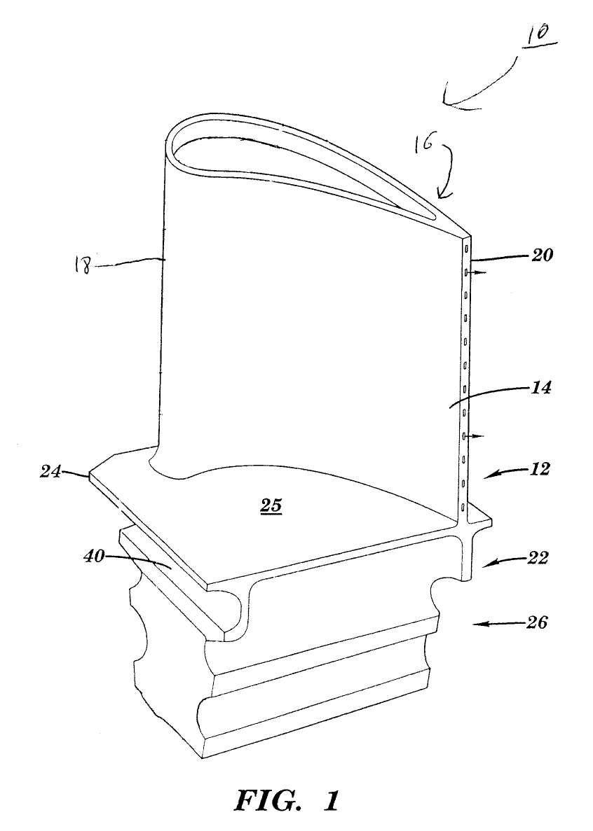

### DETAILED DESCRIPTION OF THE INVENTION

In the following description, like reference characters designate like or corresponding parts throughout the several views shown in the figures. It is also understood that terms such as “top,” “bottom,” “outward,” “inward,” “first,” “second,” and the like are words of convenience, and are not to be construed as limiting terms. Moreover, as used throughout this disclosure, the terms “a” and “an” do not denote a limitation of quantity, but rather denote the presence of at least one of the referenced items. The suffix “(s)” as used herein is intended to include both the singular and the plural of the term that it modifies, thereby including one or more of that term (e.g., the “layer” may include one or more layers).

As mentioned above, the ceramic coating is applied over a substantially smooth protective coating on a metal substrate. One protective coating of this type is a bond coat like those discussed previously, i.e., a platinum-aluminide or nickel-platinum-aluminide material. When formed by vapor deposition techniques, these coatings are very smooth e.g., less than about 60 micro-inches (Rₐ), and often, in the range of about 30-50 micro-inches. (These coatings usually have a thickness in the range of about 25 microns to about 100 microns, depending on a number of factors). As also emphasized previously, APS coatings usually have inadequate adhesion to such smooth surfaces. Other techniques are also sometimes employed to deposit these coatings; with a resulting smooth surface. Some specific examples are chemical vapor deposition (CVD); above-the-pack vapor phase diffusion; physical vapor deposition (PVD), e.g., the EBPVD technique mentioned above; and ion plasma (“cathodic arc”) processes.

The aluminide-based protective coatings mentioned above embrace a wide range of materials. In additional to conventional platinum-aluminide and nickel-platinum-aluminide materials, some of the other materials are described in U.S. Pat. No. 6,974,636 (Darolia et al); U.S. Pat. No. 6,579,627 (Darolia et al); U.S. Pat. No. 6,291,084 (Darolia et al); U.S. Pat. No. 6,255,001 (Darolia); and U.S. Pat. No. 6,153,313 (Rigney et al), all of which are incorporated herein by reference. Many of these materials are characterized as “beta-phase-” or “predominantly beta-phase” nickel aluminide materials.

In simple terms, many of the beta-phase materials can be referred to as intermetallic NiAl(CrRE) materials, wherein “RE” represents at least one reactive or “modifying” element, such as zirconium, hafnium, yttrium, silicon or cesium. In some specific embodiments, the level of each modifying element is usually in the range of about 0.1 wt % to about 5 wt % of the protective layer composition, although the level of yttrium is more often in the range of about 0.1 wt % to about 1 wt %. As a non-limiting example, a beta-phase NiAl intermetallic material can comprise, in atom percent, about 30% to about 60% aluminum; about 2% to about 15% chromium; and about 0.1% to about 1.2% (each) of at least one of the modifying elements noted above; with the balance essentially nickel. In many instances, the addition of the modifying element(s) also appears to promote adhesion of the ceramic (TBC) layer to the protective layer, thereby increasing the service life of the resulting TBC system.

The “substantially smooth” protective surface for the purpose of this disclosure is a surface with an Rₐ as low as about 60 micro-inches, and as high as about 200 micro-inches. Usually, “substantially smooth surfaces” are in the range of about 60 to about 100 micro-inches. Thus, prior to spraying, it may be necessary to roughen a surface which has an Rₐ less than that range, e.g., the smooth, “virgin” surface of a vapor-deposited platinum-aluminide coating as described above (30-50 micron-inches). Any conventional abrading or roughening step can be undertaken, as long as the technique does not damage the surface being coated. Non-limiting examples include grit blasting, hand sanding with fine abrasive paper, and chemical etching with a strong acid. Grit blasting can itself be carried out in a number of ways. As one example, a light grit-blasting step can be carried out by directing a pressurized air stream containing silicon carbide particles across the surface at a pressure of less than about 80 psi. It should be emphasized that the resulting surface is still much smoother than the relatively rough surfaces typically required for successful APS spraying, as described below.

As mentioned above, the ceramic coating is usually (though not always) a thermal barrier coating (TBC). In some preferred embodiments, the ceramic coating is zirconia-based. Zirconia is a well-known compound for barrier coatings, and is described, for example, in U.S. Pat. No. 6,180,260 (Gray et al), which is incorporated herein by reference. Zirconia is usually employed in a fully- or partially-stabilized form, by being blended with minor amounts of certain materials, e.g., oxides such as yttrium oxide (yttria), magnesia, scandia, calcium oxide, or various rare earth oxides. Other types of ceramic coatings for various end uses may be employed as well. Non-limiting examples include mullite, silicon carbide, or BSAS (barium strontium aluminosilicate). (It should be understand that this overlying ceramic coating can also be thought of as a “protective coating”. However, for the purpose of clarity, the latter term is generally used herein to describe an underlying, smooth protective coating, such as the aluminide-type bond coats).

As also discussed previously, the ceramic coating is applied over the substantially smooth protective coating by air plasma spraying (APS). The plasma techniques are generally known in the art. (See, for example, the Kirk-Othmer Encyclopedia of Chemical Technology, 3rd Edition, V. 15, page 255, and references noted therein. U.S. Pat. No. 5,332,598 (Kawasaki et al); U.S. Pat. No. 5,047,612 (Savkar and Liliquist); U.S. Pat. No. 4,741,286 (Itoh et al); and U.S. Pat. No. 4,455,470 (Klein et al)). These references are instructive in regard to various aspects of plasma spraying. and are incorporated herein by reference.

In these techniques, an electric arc is typically used to heat various gasses, such as air, oxygen, nitrogen, argon, helium, or hydrogen, to temperatures of about 8000° C., or higher. (When the process is carried out in an air environment, it is often referred to as “APS”). The gasses are expelled from an annulus at high velocity, creating a characteristic thermal plume. Powder material (e.g., the zirconia-based composition) is fed into the plume, and the melted particles are accelerated toward the substrate being coated.

The typical plasma spray system includes a plasma gun anode which has a nozzle pointed in the direction of the deposit-surface of the substrate being coated, e.g., the airfoil section of a turbine blade. The plasma gun is often controlled automatically, e.g., by a robotic mechanism, which is capable of moving the gun in various patterns across the substrate surface. The plasma plume extends in an axial direction between the exit of the plasma gun anode and the substrate surface.

Some type of powder injection means is disposed at a predetermined, desired axial location between the anode and the substrate surface. In some cases, the powder injection means is spaced apart in a radial sense from the plasma plume region, and an injector tube for the powder material is situated in a position so that it can direct the powder into the plasma plume at a desired angle. The powder particles, entrained in a carrier gas, are propelled through the injector and into the plasma plume. The particles are then heated in the plasma and propelled toward the substrate. The particles melt (as discussed below), impact on the substrate, and quickly cool to form the thermal barrier coating.

As noted below, a number of parameters are associated with the effective deposition of a TBC coating from an APS system. The present invention is based on the discovery that an adjustment in two of these parameters unexpectedly results in a coating which has greatly improved adhesion to a relatively smooth, underlying surface. The parameters are coating particle size, and particle velocity.

In the present case, the ceramic coating particles have an average particle size no greater than about 50 microns. In some specific embodiments, the average particle size is no greater than about 25 microns. The minimum, average particle size for most embodiments is about 1 micron. (It is thought that, in some instances, particles smaller than about 1 micron may not effectively deposit on the target-surface after traveling through the air plasma. See, for example, an article by Berghaus, et. al., entitled “Injection Conditions and in-Flight Particle States in Suspension Plasma Spraying of Alumina and Zirconia Nano-Ceramics,” Proceeding of 2005 International Thermal Spray Conference, Basel, Switzerland, May, 2005). A preferred particle size for some situations is in the range of about 5 microns to about 50 microns. In some especially preferred embodiments, the particle size is in the range of about 5 microns to about 25 microns, i.e., substantially all of the particles within a given sample fall into that size range. In general, these particle sizes are substantially smaller than a typical ceramic TBC material used in APS, e.g., Sulzer Metco 204NS 8 wt % yttria stabilized zirconia powder, wherein the particle size is in the range of about 11 to about 125 microns.

The pre-selected particle velocity for the ceramic coating particles in this process is at least about 500 meters per second. In some specific embodiments, the velocity is at least about 600 meters per second, and often, in the range of about 600 meters per second to about 700 meters per second. These particle velocities are substantially greater than the typical velocities used in APS. As an example, a plasma spray gun in a typical APS process would provide coating particle velocities in the range of about 150-250 meters per second.

Various techniques are available for measuring particle velocity downstream from the plasma gun exit, using a variety of sensor systems. As a non-limiting example, measuring systems for determining particle velocity and particle velocity distribution are described in U.S. Pat. No. 6,862,536 (Rosin). One example of an on-line particle monitoring and measurement device which is commercially available is the DPV-2000 system, available from Tecnar Automation Ltd, Montreal, Canada (http://www.tecnar.com/).

Conventional APS systems can be modified to effectively increase the plasma velocity and hence, the particle velocity, according to this invention. In general, modification of the APS system in this instance involves the selection of different configurations of anode nozzles which fit into the plasma spray guns. In the present case, commercial air plasma spray guns equipped with high-velocity anode nozzles can be employed to carry out the high velocity air plasma spray (HV-APS) process. Non-limiting examples include the 7 MB (or 9 MB) plasma spray gun equipped with the 704 high velocity nozzle, available from Sulzer Metco, Inc. Another example is the SG100® plasma spray gun, operated in the “Mach 2” mode, available from Praxair Surface Technologies, Inc.

The temperature of the coating particles within the plasma can also be a significant consideration for the present invention. In general, the temperature of the coating particles during air plasma-spraying is at least the melting temperature of the ceramic material. In some preferred embodiments, the coating particle temperature should be greater than the melting temperature of the material, e.g., at least about 100° C. greater than its melting point, and in some especially preferred embodiments, at least about 200° C. greater than its melting point. Those skilled in the art are familiar with adjustments in the APS systems (such as power levels) which will serve to heat the coating particles to the desired temperature.

Those of ordinary skill in the plasma spray coating art are familiar with other details which are relevant to applying coatings by APS techniques. Examples of the other steps and process parameters include: Cleaning of the surface prior to deposition; grit blasting to remove oxides; substrate temperature; plasma spray parameters such as spray distances (gun-to-substrate); selection of the number of spray-passes, powder feed rate, torch power, plasma gas selection; angle-of-deposition, post-treatment of the applied coating; and the like. In a typical situation, the torch power varies in the range of about 40 kilowatts to about 200 kilowatts.

The thickness of the ceramic coating will depend on the end use of the part being coated. In the case of thermal barrier coatings, the thickness is usually in the range of about 100 microns to about 2500 microns. In some specific embodiments for end uses such as airfoil components, the thickness is often in the range of about 125 microns to about 750 microns.

In preferred embodiments, the ceramic coating applied by the high velocity APS (“HV-APS”) process described herein comprises a dense, strain-tolerant, vertically-cracked ceramic layer, e.g., a layer comprising yttria stabilized zirconia (YSZ). It is believed that the high particle velocity produced by the high velocity APS process promotes better “splat-to-splat” bonding; reduces splat-to-splat voids; and increases coating density, thereby resulting in coordinated vertical micro-crack formation. This type of microstructure is described in various references. Examples include U.S. Pat. No. 6,306,517 (Gray et al) and U.S. Pat. No. 6,740,364 (Lau et al), which are incorporated herein by reference. The microstructure and crack pattern often can considerably enhance the physical and mechanical properties of these coatings, e.g., in ways which are intended to improve their resistance to spalling in cyclic high temperature environments. Moreover, as described herein, the desired microstructure for this invention is achieved with a coating which has very good adhesion to a smooth, underlying surface, e.g., a bond strength of at least about 2000 psi, and preferably, at least about 4000 psi. This phenomenon appears to be due, in part, to the high velocity of the coating particles.

Another type of “substantially smooth protective coating” to which the ceramic coating can be applied is an underlying, smooth ceramic coating. As an example, the underlying coating could be a zirconia-based TBC which has been applied by an EBPVD or other type of vapor deposition technique. Since each EBPVD coating is relatively smooth (e.g., an Rₐ of about 30 to about 150 micro-inches), adhesion of a subsequently-applied APS coating to an EBPVD coating by conventional techniques may be relatively poor. Thus, use of the present process can substantially eliminate this problem, while still retaining the benefits of APS capabilities. As alluded to above in regard to EBPVD, it can be very difficult to control coating thickness on various surfaces of a part when those surfaces are out-of-plane with each other. In contrast, the APS process described herein can be very effective at tailoring the thickness to individual areas, e.g., the platform area of a turbine blade.

Turbine blades are often exemplified as the “metal substrate” in this patent specification. However, many types of turbine components can benefit from the various embodiments of this invention. Non-limiting examples include buckets, nozzles, rotors, disks, vanes, stators, blisks, shrouds, and combustors. Moreover, the components can be part of land turbines, aircraft engine turbines, or marine turbines. Furthermore, other types of components could serve as metal substrates for the ceramic coatings. As one example, the substrate may be the piston head of a diesel engine.

### EXAMPLES

The examples which follow are merely illustrative, and should not be construed to be any sort of limitation on the scope of the claimed invention.

### Example 1

A number of test coupons (“buttons”) were prepared. The substrate was a nickel-based material (Rene® N-5). Two button samples were prepared for tensile adhesion tests; and three test buttons were prepared for furnace cycle (FCT) tests. Each button had an outer diameter of about 1 inch (2.54 cm); and was about ⅛ inch (0.3 cm) thick.

A bond coat (standard, single-phase nickel-platinum-aluminide) was applied to the surface of each button. The application technique involved plating with platinum, followed by aluminiding by an above-the-pack process. The thickness of each coating was about 50 microns. The surface roughness of each coating, as applied, was less than about 50 micro-inches (Rₐ).

After the deposition of the bond coat, the surface of each button was grit-blasted with 80-mesh alumina grit (Al₂O₃), in a pressure grit-blaster. The air pressure was 70-80 psi. The average surface roughness (Rₐ) after grit blasting was about 65 micro-inches, as measured with Mitutoyo Surftest™ 402 surface profilometer. Each button was washed with alcohol before deposition of the ceramic coating.

The ceramic powder used was a yttria-stabilized zirconia powder, available from H.C. Starck (Amperit® 825.0). The powder contained 7 wt % yttria, with a particle size between 5-22 microns. The “d5” parameter for the powder (diameter of particles in the 5 percentile) was approximately 5.5 microns. The “d90” parameter for the particles (diameter of particles in the 90 percentile) was approximately 31 microns.

(It should be noted that a typical yttria-stabilized zirconia powder contains powder particles, which on average, are substantially larger than the Amperit material. As an example, the Sulzer Metco 204NA powder usually has the following characteristics:
d10 (10 percentile)—approximately 25 microns;
d50 (50 percentile)—approximately 55 microns;
d90 (90 percentile)—approximately 97 microns).

The following spray parameters were generally maintained in the process:
Spray Gun: Praxair Surface Technologies Model SG100 gun with P/N 2083-100 Mach II anode and 1083A-104 cathode
Gun Current: 760-900 Amperes
Argon Gas Flow: 150-200 scfh (standard cubic feet per hour)
Helium Gas Flow: 80-190 scfh
Powder Argon Carrier Gas Flow: 23 scfh
Powder Feed Rate: 1 lb/hour
Spray Distance: 2 inch (5.1 cm)
Gun Speed: 600 mm/sec
Particle Temperature (measured by DPV-2000 as surface temperature): greater than or equal to 2900° C.
Particle Velocity (measured by DPV-2000: Greater than 600 m/sec.
Steady-State Substrate Deposition Temperature: 210-220° C.
Ceramic Coating Thickness˜150-300 microns
TBC Vacuum Heat-Treatment: 20° F./min ramp up to 2000° F.; held at 2000° F. for 2 hours, followed by furnace cool.

The tensile test was carried out according to ASTM C633-01, the standard bond test. The furnace cycle test (FCT) generally measures the endurance of a coating. It was carried out by raising the sample temperature to 2075° F. in 10 minutes (bottom-loading CM furnace), followed by a hold-period of 45 minutes; and then cooling to less than 500° F. in 9 minutes. The cycle is repeated until more than 20% of the surface area of the ceramic coating (e.g., a TBC) spalls from the underlying surface.

After tensile testing, the two buttons exhibited a ceramic coating bond strength of 6253 psi. This high level of adhesion was generally equivalent to that which would be obtained for a ceramic coating applied conventionally on a rough surface, as described above. (The level of adhesion is much greater than that which would be obtained for coatings applied on a smooth surface).

The average FCT life for the three buttons was about 250 cycles. In some cases, the FCT performance is less than that which is typically obtained with conventional coatings applied by EBPVD, but in other cases, the comparative performance is substantially identical. The FCT performance observed in this instance is suitable for coatings being used in a number of end use applications.

Moreover, the ceramic coating was characterized by a very dense microstructure, with a large number of vertical cracks. Image analysis techniques showed a density of over 95%, with a crack density of greater than 60 cracks-per-inch.

While this invention has been described in detail, with reference to specific embodiments, it will be apparent to those of ordinary skill in this area of technology that other modifications of this invention (beyond those specifically described herein) may be made, without departing from the spirit of the invention. Accordingly, the modifications contemplated by those skilled in the art should be considered to be within the scope of this invention. Furthermore, all of the patents, patent publications, articles, texts, and other references mentioned above are incorporated herein by reference.

What is claimed is:

1. A method for applying a ceramic coating over a substantially smooth protective coating on a metal substrate, comprising the step of air plasma spraying (APS) particles of the ceramic coating over the substantially smooth protective coating at a pre-selected particle velocity, wherein
a) the ceramic coating particles have an average particle size no greater than about 50 microns; and
b) the pre-selected particle velocity is at least about 500 meters per second.

2. The method of claim 1, wherein the ceramic coating comprises yttria-stabilized zirconia.

3. The method of claim 1, wherein the protective coating has a surface roughness (Rₐ) no greater than about 200 micro-inches.

4. The method of claim 3, wherein the protective coating has a surface roughness (Rₐ) of at least about 60 micro-inches.

5. The method of claim 1, wherein the protective coating on the metal substrate has a surface roughness (Rₐ) of less than about 60 micro-inches, and is roughened to a surface roughness of at least about 60 micro-inches, prior to the step of air plasma spraying.

6. The method of claim 5, wherein the protective coating is roughened to a surface roughness in the range of about 60 micro-inches to about 100 micro-inches, prior to the step of air plasma spraying.

7. The method of claim 5, wherein roughening is carried out by a technique which comprises grit-blasting.

8. The method of claim 1, wherein the protective coating comprises a metallic material or a ceramic material.

9. The method of claim 8, wherein the metallic material comprises aluminum.

10. The method of claim 9, wherein the metallic material comprises a nickel-aluminide material, a platinum-aluminide material, or a nickel-platinum-aluminide material.

11. The method of claim 9, wherein the metallic material comprises a beta phase or predominantly beta-phase nickel-aluminide intermetallic alloy which contains at least one reactive element selected from the group consisting of zirconium, hafnium, yttrium, silicon, and cesium.

12. The method of claim 8, wherein the metallic material has been formed on the substrate by a vapor deposition process or an ion plasma (cathodic arc) process.

13. The method of claim 12, wherein the vapor deposition process comprises a vapor phase aluminiding (VPA) technique.

14. The method of claim 8, wherein the ceramic material forming the protective coating comprises yttria-stabilized zirconia.

15. The method of claim 8, wherein the ceramic material forming the protective coating has been applied to the substrate by an electron beam physical vapor deposition (EBPVD) technique.

16. The method of claim 1, wherein the ceramic coating particles have an average particle size in the range of about 5 microns to about 25 microns.

17. The method of claim 1, wherein the pre-selected particle velocity is at least about 600 meters per second.

18. The method of claim 1, wherein the coating particles are air plasma-sprayed while at a temperature of at least the melting temperature of the ceramic material.

19. The method of claim 1, wherein the ceramic coating has a thickness in the range of about 100 microns to about 2500 microns.

20. The method of claim 1, wherein the metal substrate comprises a portion of a turbine component.

21. The method of claim 20, wherein the turbine component is a turbine blade.

22. An article, comprising
(I) a metal substrate;
(II) a substantially smooth protective coating over the substrate, having a roughness (Ra) less than about 200 micro-inches; and
(III) an adherent ceramic coating disposed on the substantially smooth protective coating;
wherein the adherent ceramic coating has been applied by air plasma spraying.

23. The article of claim 22, wherein the ceramic coating comprises a partially-stabilized or fully-stabilized zirconia material.

24. The article of claim 22, wherein the substantially smooth protective coating (II) comprises a nickel-aluminide material, a platinum-aluminide material, or a nickel-platinum-aluminide material.

25. The article of claim 22, wherein the substantially smooth protective coating (II) comprises a beta phase or predominantly beta-phase nickel-aluminide intermetallic alloy which contains at least one reactive element selected from the group consisting of zirconium, hafnium, yttrium, silicon, and cesium.

26. The article of claim 22, wherein the adherent ceramic coating of element (III) comprises a dense, vertically-cracked yttria-stabilized zirconia (YSZ) material.
